(19) United States
(12) Patent Application Publication
(10) Pub. No.: US 2026/0029734 A1
(43) Pub. Date: Jan. 29, 2026

(54) POWER TRANSMISSION MECHANISM, FIXING DEVICE, AND IMAGE FORMING APPARATUS

(71) Applicant: Konica Minolta, Inc., Tokyo (JP)

(72) Inventor: Hideaki IKEDA, Toyokawa-shi (JP)

(21) Appl. No.: 19/278,933

(22) Filed: Jul. 24, 2025

(30) Foreign Application Priority Data
Jul. 25, 2024 (JP) 2024-119236

(51) Int. Cl. G03G 15/20; F16H 1/20; F16H 55/06

(52) U.S. Cl. CPC G03G 15/2035; F16H 1/20; F16H 55/06; G03G 15/2064

(57) ABSTRACT

A power transmission mechanism includes a partially toothless gear in which teeth are formed only in a part of a peripheral edge portion and which is rotationally driven and a first gear having a plurality of teeth formed on a peripheral edge portion thereof, meshing with the teeth of the partially toothless gear by rotation of the partially toothless gear and being rotationally driven by the rotation of the partially toothless gear. The first gear is movable between a first position at which a tip of the plurality of teeth and a tip of the teeth of the partially toothless gear collide with each other and a second position farther from the partially toothless gear than the first position.

### CROSS REFERENCE TO RELATED APPLICATIONS

The present invention claims priority under 35 U.S.C. § 119 to Japanese Patent Application No. 2024-119236 filed on Jul. 25, 2024, the contents of which are incorporated herein by reference.

### BACKGROUND OF THE INVENTION

### Technical Field

The present invention relates to a power transmission mechanism, a fixing device, and an image forming apparatus.

### Description of Related Art

An image forming apparatus such as an MFP (Multifunction Peripheral) is equipped with various power transmission mechanisms. Conventionally, for example, as a power transmission mechanism used in a sheet feed roller drive system, a mechanism provided with a first gear and a second gear having a toothless portion is known (e.g., Japanese Unexamined Patent Publication No. H06-50406 (patent literature)). In such a power transmission function, when the teeth of the second gear having the toothless portion are engaged with the teeth of the first gear having a plurality of teeth arranged at equal intervals over the entire circumference, there is a possibility that the tooth tips of the first gear and the tooth tips of the second gear collide with each other. When the tooth tip of the first gear and the tooth tip of the second gear collide with each other, both the first gear and the second gear cannot rotate normally. Therefore, if the rotating shaft of one of the gears is forcibly rotated, tooth of each of the gears are damaged. In order to prevent this, in the power transmission mechanism disclosed in the patent literature, the tooth portion located on the downstream side of the toothless portion in the rotation direction of the second gear is configured to be elastically deformable. That is, in the power transmission mechanism of the related art, in a case where the tooth tips collide with each other when the tooth tip of the first gear and the tooth tip of the second gear mesh with each other, the tooth portion of the second gear is contracted and deformed in the radial direction, thereby preventing the breakage of the tooth.

Incidentally, the power transmission mechanism as described above is also mounted in a fixing device that is exposed to a high temperature environment during operation. The power transmission mechanism mounted in the fixing device is required to have sufficient heat resistance, and for example, a polyphenylene sulfide (PPS) resin having particularly excellent heat resistance among thermoplastic resins is used. The PPS resin also has high dimensional stability in addition to high heat resistance. Therefore, the PPS resin is suitable for a material forming a gear of a power transmission mechanism.

However, on the other hand, since the PPS resin does not have elasticity, the PPS resin is less likely to be deformed and has low impact resistance. Therefore, when the gear of the power transmission mechanism is formed by using the PPS resin, there is a problem that an elastically deformable configuration as in the above-described related art cannot be adopted.

### SUMMARY OF THE INVENTION

The present invention has been devised in order to solve the above-described conventional problems. That is, an object of the present invention is to provide a power transmission mechanism, a fixing device, and an image forming apparatus that can prevent breakage of teeth in a case where tooth tips collide with each other, without elastically deforming gears.

A first subject of the invention is directed to a power transmission mechanism.

According to an aspect of the first subject, the power transmission mechanism includes a partially toothless gear in which teeth are formed only in a part of a peripheral edge portion and which is rotationally driven and a first gear having a plurality of teeth formed on a peripheral edge portion thereof, meshing with the teeth of the partially toothless gear by rotation of the partially toothless gear and being rotationally driven by the rotation of the partially toothless gear. The first gear is movable between a first position at which a tip of the plurality of teeth and a tip of the teeth of the partially toothless gear collide with each other and a second position farther from the partially toothless gear than the first position.

A second subject of the present invention is directed to a fixing device.

According to an aspect of the second subject, the fixing device includes a heating roller, a pressure roller, a first support portion that supports the heating roller, a second support portion that supports the pressure roller and is movable relative to the first support portion in a contact and separation direction, a holding member that holds the second support portion and the first support portion in a state of being close to each other, a pressing portion that presses the second support portion and the first support portion against holding force of the holding member in a direction in which the second support portion and the first support portion are separated from each other, and a power transmission mechanism. The power transmission mechanism includes a partially toothless gear in which teeth are formed only in a part of a peripheral edge portion and which is rotationally driven and a first gear having a plurality of teeth formed on a peripheral edge portion thereof, meshing with the teeth of the partially toothless gear by rotation of the partially toothless gear and being rotationally driven by the rotation of the partially toothless gear. The first gear is movable between a first position at which a tip of the plurality of teeth and a tip of the teeth of the partially toothless gear collide with each other and a second position farther from the partially toothless gear than the first position. The partially toothless gear is rotationally driven and rotates the first gear in a state in which the partially toothless gear and the first gear are engaged with each other so that the pressing portion is operated to separate the second support portion and the first support portion from each other.

A third subject of the present invention is directed to an image forming apparatus.

According to an aspect of the third subject, the image forming apparatus includes a fixing device and a controller. The fixing device includes a heating roller, a pressure roller, a first support portion that supports the heating roller, a second support portion that supports the pressure roller and is movable relative to the first support portion in a contact and separation direction, a holding member that holds the second support portion and the first support portion in a state of being close to each other, a pressing portion that presses the second support portion and the first support portion against holding force of the holding member in a direction in which the second support portion and the first support portion are separated from each other, and a power transmission mechanism. The power transmission mechanism includes a partially toothless gear in which teeth are formed only in a part of a peripheral edge portion and which is rotationally driven and a first gear having a plurality of teeth formed on a peripheral edge portion thereof, meshing with the teeth of the partially toothless gear by rotation of the partially toothless gear and being rotationally driven by the rotation of the partially toothless gear. The first gear is movable between a first position at which a tip of the plurality of teeth and a tip of the teeth of the partially toothless gear collide with each other and a second position farther from the partially toothless gear than the first position. The partially toothless gear is rotationally driven and rotates the first gear in a state in which the partially toothless gear and the first gear are engaged with each other so that the pressing portion is operated to separate the second support portion and the first support portion from each other. The controller drives the partially toothless gear rotationally in a predetermined state to separate the second support portion and the first support portion from each other.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a conceptual diagram illustrating an overall configuration of an image forming apparatus in which a power transmission mechanism is mounted;

FIG. 2 is a perspective view illustrating a fixing device;

FIG. 3 is a perspective view illustrating a power transmission mechanism;

FIG. 4A and FIG. 4B are diagrams illustrating changes of the fixing device by the power transmission mechanism;

FIG. 5 is a diagram illustrating a support plate;

FIG. 6A and FIG. 6B are diagrams illustrating movement of the first gear attached to the outside of the support plate;

FIG. 7A and FIG. 7B are diagrams illustrating displacement of a rotation axis;

FIG. 8A, FIG. 8B, FIG. 8C, and FIG. 8D are diagrams illustrating operation of the power transmission mechanism;

FIG. 9 shows the movement direction of the first gear relative to the second gear;

FIG. 10 is a diagram illustrating a movement direction of a first gear with respect to a partially toothless gear;

FIG. 11 is a flowchart illustrating a procedure of drive control of the power transmission mechanism by the controller; and

FIG. 12A and FIG. 12B are views showing an example of an urging member for urging the first gear toward the first position.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

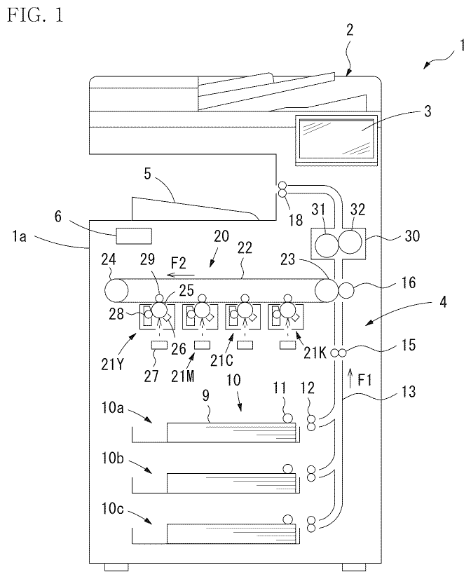

FIG. 1 is a conceptual diagram illustrating an overall configuration of an image forming apparatus 1 in which a power transmission mechanism 50 according to an embodiment of the present disclosure is mounted. The image forming apparatus 1 is, for example, a multifunction peripheral (MFP) and has multiple functions such as a scanning function and a printing function. The image forming apparatus 1 includes a scanner unit 2 on an upper portion of an apparatus body 1a. The scanner unit 2 generates image data by optically reading an image of a document set by a user. The image forming apparatus 1 includes an operation panel 3 on a front surface side of the scanner unit 2. The operation panel 3 is a user interface for a user to use the image forming apparatus 1. The operation panel 3 displays an operation screen that can be operated by a user and receives an operation by the user. Further, the image forming apparatus 1 includes a printer unit 4 at a lower portion of the apparatus body 1a. The printer unit 4 forms and outputs an image on a sheet.

As shown in FIG. 1, the printer unit 4 includes a sheet feed and conveyance section 10, an image forming section 20, and a fixing device 30. The printer unit 4 includes a controller 6 that performs overall control of the operation of the image forming apparatus 1.

The sheet feed and conveyance section 10 feeds a sheet 9 from any one of the plurality of sheet feed trays 10a, 10b, and 10c, and conveys the sheet 9 along a conveyance path 13 formed inside the printer unit 4. The plurality of sheet feed trays 10a, 10b, and 10c may accommodate sheet 9 of different types or sheet 9 of the same type. Each of the sheet feed trays 10a, 10b, and 10c is provided with a pickup roller 11 and a sheet feed roller 12. The sheet feed and conveyance section 10 drive a pickup roller 11 and a sheet feed roller 12 provided in one sheet feed tray specified by a user, to feed the sheet 9 toward a conveyance path 13. The sheet feed and conveyance section 10 convey the sheet 9 sent to the conveyance path 13 along the direction of the arrow F1 shown in FIG. 1.

The conveyance path 13 is provided with a timing roller 15, a secondary transfer roller 16, a fixing device 30, and a sheet ejection roller 18.

The timing roller 15 is composed of a pair of rollers. The timing roller 15 is a roller that adjusts the timing at which the sheet 9 is fed to the secondary transfer position by the secondary transfer roller 16. When a leading end of the sheet 9 fed from one of the sheet feed trays 10a, 10b, and 10c reaches a position of the timing roller 15, the sheet feed and conveyance section 10 temporarily stops conveyance of the sheet 9. The sheet feed and conveyance section 10 then drive the timing roller 15 in accordance with the timing at which the image primarily transferred onto the intermediate transfer belt 22 in the image forming section 20 is conveyed to the secondary transfer position, to convey the sheet 9 toward the secondary transfer roller 16. When the sheet 9 fed from the timing roller 15 passes through a secondary transfer position by the secondary transfer roller 16, an image is secondarily transferred onto the sheet 9. Then, the sheet 9 to which the image is secondarily transferred advances toward the fixing section 17.

The image forming section 20 includes image forming units 21Y, 21M, 21C, and 21K corresponding to the colors yellow (Y), magenta (M), cyan (C), and black (K), and an intermediate transfer belt 22.

The image forming unit 21Y is a unit that forms a Y color image. The image forming unit 21Y includes an image bearing member 25 formed with a photosensitive drum or the like, a charging device 26, an exposure device 27, and a developing device 28. The image bearing member 25 has a photosensitive layer on the surface of a cylindrical body, and rotates in a predetermined direction (clockwise direction). The charging device 26, the exposure device 27, and the developing device 28 are disposed around the image bearing member 25. The charging device 26 charges the surface of the image bearing member 25 to a predetermined charge. The exposure device 27 exposes the charged surface of the image bearing member 25 on the basis of image data to form an electrostatic latent image on the surface of the image bearing member 25. The developing device 28 supplies a developer containing toner to the surface of the image bearing member 25 and develops the electrostatic latent image with the toner. Thus, an image (toner image) is formed on the surface of the image bearing member 25 according to the corresponding image data. The other image forming units 21M, 21C, and 21K have the same configuration as the image forming unit 21Y and are different only in the color of the toner supplied to the image bearing member 25. That is, a plurality of image forming units 21Y, 21M, 21C, and 21K having the same configuration are arranged horizontally at predetermined intervals.

The intermediate transfer belt 22 is an endless belt disposed above the image forming units 21Y, 21M, 21C, and 21K. The intermediate transfer belt 22 is wound around a driving roller 23 provided at a position facing the secondary transfer roller 16 and a driven roller 24 provided at a position separated from the driving roller 23 by a predetermined interval in the horizontal direction. As the driving roller 23 is rotationally driven in the counterclockwise direction, the intermediate transfer belt 22 circulates in a direction indicated by an arrow F2 in FIG. 1. The intermediate transfer belt 22 contacts the secondary transfer roller 16 at the position of the driving roller 23.

Inside the intermediate transfer belt 22, primary transfer rollers 29 are provided at positions opposing the image forming units 21Y, 21M, 21C, and 21K, respectively. The primary transfer rollers 29 press the intermediate transfer belt 22 against the surfaces of the image bearing member 25 of the image forming units 21Y, 21M, 21C, and 21K. In such a state, a predetermined voltage is applied to the primary transfer roller 29. Thus, the image (toner image) formed on the surface of the image bearing member 25 is primary transferred onto the intermediate transfer belt 22. The respective image forming units 21Y, 21M, 21C, and 21K primarily transfer the respective images of Y, M, C, and K onto the intermediate transfer belt 22 while sequentially superimposing the images. As the result, a color image is formed on the surface of the intermediate transfer belt 22. The image transferred to the intermediate transfer belt 22 is secondarily transferred to the sheet 9 at a position of the secondary transfer roller 16.

The fixing device 30 fixes the image to the sheet 9 by performing a heating process and a pressing process on the sheet 9 to which the image has been secondarily transferred. The fixing device 30 includes a heating roller 31 and a pressure roller 32. The heating roller 31 and the pressure roller 32 contact each other to form a nip portion. The heating roller 31 and the pressure roller 32 sandwich the sheet 9 at their nip portion to perform heating processing and pressure processing. The surface temperature of the heating roller 31 is heated to a fixing temperature suitable for the type (for example, basis weight) of the sheet 9 by the controller 6. The toner transferred to the sheet 9 is melted by the heating processing by the heating roller 31, and the melted toner is fixed to the sheet 9 by the pressure processing by the pressure roller 32. The sheet 9 on which the image is fixed in the fixing device 30 is discharged onto a sheet ejection tray 5 formed on an upper portion of the printer unit 4 via a sheet ejection roller 18.

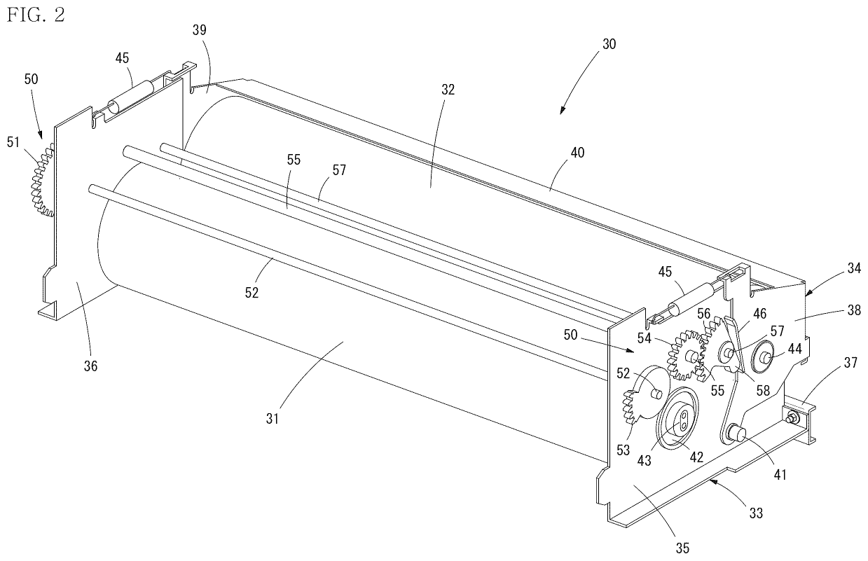

FIG. 2 is a perspective view showing the fixing device 30. The fixing device 30 includes a first support portion 33 that rotatably supports the heating roller 31 and a second support portion 34 that rotatably supports the pressure roller 32.

The first support portion 33 includes a pair of support plates 35 and 36 disposed at both ends of the heating roller 31 in the longitudinal direction, and the pair of support plates 35 and 36 are connected to each other by a connecting member 37. The connecting member 37 traverses between the pair of support plates 35 and 36 and couples and fixes the support plates 35 and 36 to both ends thereof. Therefore, the connecting member 37 holds the pair of support plates 35 and 36 at a predetermined interval so as not to relatively change their postures.

The pair of support plates 35 and 36 are provided with bearing portion 42 that support end portion 43 of the heating roller 31. The end portion 43 of the heating roller 31 are mounted on the bearing portion 42, and thus the pair of support plates 35 and 36 pivotally support the heating roller 31 in a rotatable manner. A heat source such as a halogen heater is built in the heating roller 31. Therefore, the bearing portion 42 has a configuration in which an electric cable can be connected to the heat source.

The second support portion 34 has a pair of side plate parts 38, 39 arranged at both ends in the longitudinal direction of the pressure roller 32, and a cover portion 40 connecting the pair of side plate parts 38, 39 and covering the outer peripheral surface of the pressure roller 32. For example, the pair of side plate parts 38, 39 and the cover portion 40 are integrally formed. An interval between the pair of side plate parts 38 and 39 is wider than an interval between the pair of support plates 35 and 36 of the first support portion 33. Therefore, the pair of side plate parts 38 and 39 are disposed outside the pair of support plates 35 and 36 of the first support portion 33. The pair of side plate parts 38 and 39 are provided with bearing portions for supporting the end portion 44 of the pressure roller 32. The end portion 44 of the pressure roller 32 are mounted in the bearing portions, and thus the pair of side plate parts 38 and 39 pivotally support the pressure roller 32 in a rotatable manner.

In the second support portion 34, lower portions of the pair of side plate parts 38 and 39 are connected to the first support portion 33 by a fulcrum shaft 41. The fulcrum shaft 41 is a rotation shaft for relatively changing the posture of the second support portion 34 and the first support portion 33. For example, in a case where the first support portion 33 is fixed to the inside of the image forming apparatus 1, the posture of the second support portion 34 with respect to the first support portion 33 changes when the second support portion 34 rotates about the fulcrum shaft 41. The second support portion 34 is relatively movable in a contact and separation direction with respect to the first support portion 33 by rotating on the fulcrum shaft 41. When the second support portion 34 moves in a direction away from the first support portion 33, the state in which the pressure roller 32 and the heating roller 31 are pressed against each other is released. In contrast, when the second support portion 34 moves in a direction approaching the first support portion 33, the pressure roller 32 and the heating roller 31 are joined to each other to form a nip portion.

In the second support portion 34, upper portions of the pair of side plate parts 38 and 39 are connected to the first support portion 33 via a holding member 45. The holding member 45 is formed of an elastic member such as a compressed coil spring, for example. The holding member 45 holds the pressure roller 32 and the heating roller 31 in a state of being joined to each other by biasing the second support portion 34 in a direction of approaching the first support portion 33. The second support portion 34 and the first support portion 33 are held by the holding member 45 in a state of being close to each other, so that a nip portion between the pressure roller 32 and the heating roller 31 is formed. As a result, the sheet 9 on which the image has been formed can be subjected to the heating process and the pressurizing process, and the image can be fixed to the sheet.

Further, the second support portion 34 has an inclined plate 46 at the center of the end portions of the pair of side plate parts 38 and 39, the inclined plate 46 being inclined such that the upper portion thereof approaches the first support portion 33. The inclined plate 46 serves as an operation portion when the second support portion 34 is moved away from the first support portion 33.

The fixing device 30 includes a power transmission mechanism 50 for driving the first support portion 33 and the second support portion 34 in a direction away from each other. The power transmission mechanism 50 is mounted on the pair of support plates 35 and 36 of the first support portion 33.

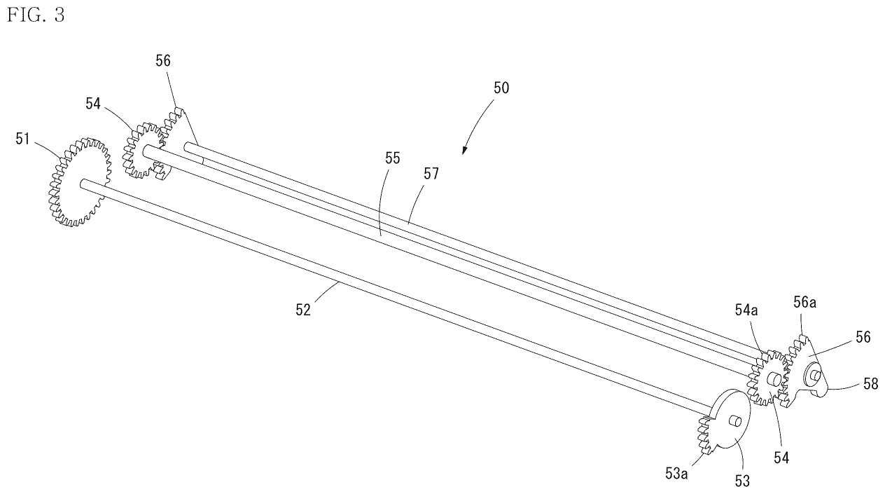

FIG. 3 is a perspective view illustrating the power transmission mechanism 50. The power transmission mechanism 50 includes a drive gear 51, a drive shaft 52, a partially toothless gear 53, a first gear 54, a second gear 56, and rotary shafts 55 and 57.

The drive gear 51 is a gear that is rotationally driven by a drive source such as a motor (not illustrated). The drive gear 51 is disposed outside the support plate 36. Note that the drive source such as a motor rotationally drives the drive gear 51 in both forward and reverse directions within a range of a predetermined angle.

The drive shaft 52 is a rotary shaft having one end to which the drive gear 51 is attached and the other end to which the partially toothless gear 53 is attached. The drive shaft 52 is disposed so as to bridge between the support plate 35 and the support plate 36. The drive shaft 52 rotates by rotational driving of the drive gear 51.

The partially toothless gear 53 is a gear in which some teeth 53a are formed in only a part of a circumferential edge portion and teeth are not formed in the other part. The partially toothless gear 53 is disposed outside the support plate 35 and is connected to the other end of the drive shaft 52. Therefore, when the drive gear 51 is rotationally driven, the partially toothless gear 53 rotates in synchronization with the drive gear 51.

The first gear 54 is disposed at two positions, i.e., outside the support plate 35 and outside the support plate 36. Two first gears 54 are connected by the rotary shaft 55. The rotary shaft 55 is disposed so as to bridge between the support plate 35 and the support plate 36, and rotatably supports the first gears 54 on the outside of the pair of support plates 35 and 36. The first gear 54 is a gear in which a plurality of teeth 54a are formed at a predetermined pitch in a peripheral edge portion. For example, the first gear 54 has teeth 54a formed on the entire circumference of the peripheral portion thereof. The first gear 54 disposed outside the support plate 35 meshes with the teeth 53a of the partially toothless gear 53 to rotate in synchronization with the rotation of the partially toothless gear 53. At this time, the two first gears 54 rotate in synchronization. However, when the first gear 54 does not mesh with the teeth 53a of the partially toothless gear 53, the first gear 54 does not rotate even when the partially toothless gear 53 rotates.

Similarly to the first gear 54, the second gear 56 is disposed at two positions, i.e., outside the support plate 35 and outside the support plate 36. Two second gears 56 are connected by the rotary shaft 57. The rotary shaft 55 is disposed so as to bridge between the support plate 35 and the support plate 36, and rotatably supports the second gears 56 on the outside of the pair of support plates 35 and 36. The second gear 56 is a gear in which a plurality of teeth 56a are formed at a predetermined pitch in a peripheral edge portion. For example, the second gear 56 is formed with the teeth 56a only in a part of the peripheral edge portion similarly to the partially toothless gear 53. However, the second gear 56 is held in a state in which a plurality of teeth 56a formed on a peripheral edge portion of the second gear 56 constantly mesh with the teeth 54a of the first gear 54. That is, when the drive gear 51 is rotationally driven by the driving source within a range of a predetermined angle, the teeth 56a of the second gear 56 are not disengaged from the first gear 54.

The second gear 56 has a pressing portion 58 on a side opposite to a portion where the teeth 56a is formed with respect to the rotary shaft 57. The pressing portion 58 is joined to the inclined plate 46 of the second support portion 34. With the rotation of the second gear 56, the pressing portion 58 presses the inclined plate 46 to move the second support portion 34 away from the first support portion 33.

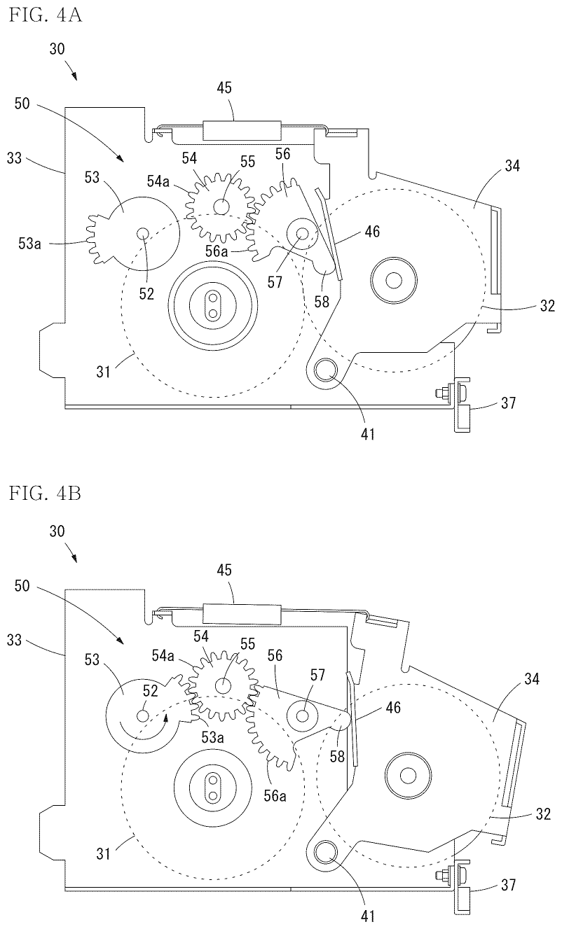

FIG. 4A and FIG. 4B are diagrams illustrating changes in the fixing device 30 by the power transmission mechanism 50. FIG. 4A shows a state in which the second support portion 34 approaches the first support portion 33, and the heating roller 31 and the pressure roller 32 are pressed against each other to form a nip portion. FIG. 4B shows a state in which the second support portion 34 is separated from the first support portion 33 and the nip portion between the heating roller 31 and the pressure roller 32 is opened.

When a print job is executed in the image forming apparatus 1, the fixing device 30 enters the state illustrated in the 4A of the figure. That is, the heating roller 31 and the pressure roller 32 are pressed against each other to form a nip portion. Next, the controller 6 drives the heat source of the heating roller 31 and performs control so that the surface temperature of the heating roller 31 becomes a predetermined fixing temperature. At this time, as illustrated in FIG. 4A, the partially toothless gear 53 waits at an initial position where the teeth 53a is disengaged from the teeth 54a of the first gear 54. For example, the initial position is a position where the partially toothless gear 53 is rotated so that the teeth 53a of the partially toothless gear 53 faces the opposite side of the first gear 54 as shown in FIG. 4A.

For example, when a jam occurs in the fixing device 30 during execution of a print job and the print job is stopped, the controller 6 drives the drive source to rotate the partially toothless gear 53 as illustrated in FIG. 4B. When the partially toothless gear 53 rotates and the teeth 53a of the partially toothless gear 53 and the teeth 54a of the first gear 54 mesh with each other, the partially toothless gear 53 rotates the first gear 54 and further rotates the second gear 56. As the second gear 56 rotates about the rotary shaft 57, a contact point between the pressing portion 58 and the inclined plate 46 moves upward and the pressing portion 58 presses the inclined plate 46. As a result, the second support portion 34 moves in a direction away from the first support portion 33 against the holding force of the holding member 45, and the nip portion between the heating roller 31 and the pressure roller 32 is opened. Thus, the sheet 9 jammed in the fixing device 30 can be removed. After the jam is eliminated, the drive source rotates the partially toothless gear 53 in the opposite direction to return it to the initial position. As a result, the first support portion 33 and the second support portion 34 approach each other again, and the heating roller 31 and the pressure roller 32 are pressed against each other.

When a print job is executed in the image forming apparatus 1, the heating roller 31 and the pressure roller 32 reach a high-temperature state. Therefore, for example, when the press-contact state continues in a state in which the heating roller 31 and the pressure roller 32 are not rotationally driven after the execution of the print job is finished, creep deformation may occur in the heating roller 31 and the pressure roller 32. Therefore, it is preferable that the controller 6 drives the drive source of the partially toothless gear 53 to release the pressure contact state between the heating roller 31 and the pressure roller 32 when the image forming apparatus 1 is in the predetermined state. The predetermined state is, for example, a state in which execution of a print job is stopped. The stop of the print job includes an emergency stop due to occurrence of a jam, normal end of the print job, and the like.

In the fixing device 30 configured as described above, the partially toothless gear 53, the first gear 54, and the second gear 56 are used in a high-temperature environment. Therefore, the partially toothless gear 53, the first gear 54, and the second gear 56 are required to have higher heat resistance as compared with a case where they are used in a power transmission mechanism of a conveyance system of the sheet 9. Therefore, in the power transmission mechanism 50 of the present embodiment, as a material for forming the partially toothless gear 53, the first gear 54, and the second gear 56, for example, a polyphenylene sulfide (PPS) resin having particularly excellent heat resistance among thermoplastic resins is used. However, the PPS resin has properties of being hardly deformed and having low resistance to impact. Therefore, if a tip end of teeth 53a of the partially toothless gear 53 and a tip end of teeth 54a of the first gear 54 collide with each other when the partially toothless gear 53 meshes with the first gear 54, one or both of the teeth 53a and the teeth 54a are likely to be damaged.

Therefore, the power transmission mechanism 50 according to the present embodiment has a structure for preventing damage to the partially toothless gear 53 and the first gear 54. Hereinafter, this will be described in detail.

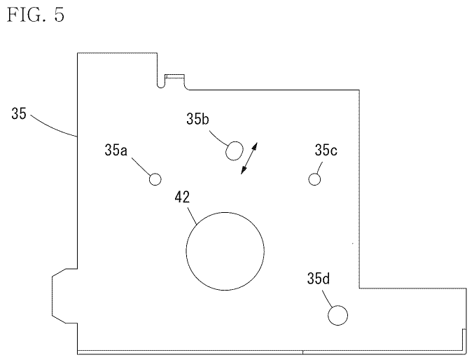

FIG. 5 is a diagram illustrating the support plate 35. The support plate 35 is provided with a shaft receiving hole 35a for rotatably supporting the drive shaft 52, a shaft receiving hole 35b for rotatably supporting the rotary shaft 55, and a shaft receiving hole 35c for rotatably supporting the rotary shaft 57. The support plate 35 is also provided with a shaft receiving hole 35d for pivotally supporting the fulcrum shaft 41.

The shaft receiving hole 35a that pivotally supports the drive shaft 52 is provided as a circular hole that is slightly larger than an outer diameter of the drive shaft 52. The shaft receiving hole 35c for pivotally supporting the rotary shaft 57 is also formed as a circular hole slightly larger than the outer diameter of the rotary shaft 57. On the other hand, the shaft receiving hole 35b for pivotally supporting the rotary shaft 55 is provided as an elongated hole having a predetermined length in a direction indicated by an arrow in FIG. 5. The shaft receiving hole 35b supports the inserted rotary shaft 55 movably along the longitudinal direction of the long hole. That is, the axis of the rotary shaft 55 supported by the support plate 35 is displaceable. For example, the shaft receiving hole 35b in the present embodiment is formed as an elongated hole having a predetermined length in an obliquely upward/downward direction.

Furthermore, a support plate 36 opposite to the support plate 35 is also provided with a plurality of shaft receiving holes at positions similar to the shaft receiving holes 35a, 35b, 35c, and 35d of the support plate 35. However, the shaft receiving hole for pivotally supporting the rotary shaft 55 in the support plate 36 is not a long hole as shown in FIG. 5, but a circular hole slightly larger than the outer diameter of the rotary shaft 55. Therefore, the axis of the rotary shaft 55 supported by the support plate 36 is not displaced.

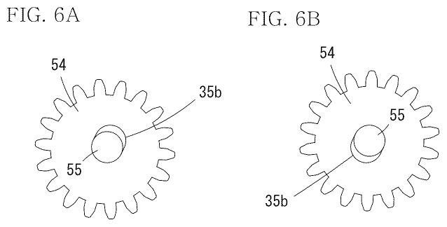

FIG. 6A and FIG. 6B are views showing the movement of the first gear 54 attached to the outer side of the support plate 35. The first gear 54 attached to the outer side of the support plate 35 moves in conjunction with the rotary shaft 55. FIG. 6A shows a state in which the first gear 54 is at a first position. The first position is a state in which the rotary shaft 55 is at one end (lower position) in the longitudinal direction of the shaft receiving hole 35b. FIG. 6B shows a state in which the first gear 54 is in a second position. The second position is a state in which the rotary shaft 55 is at the other end (upper position) in the longitudinal direction of the shaft receiving hole 35b. The first gear 54 held on the outer side of the support plate 35 is movable between the first position shown in FIG. 6A and the second position shown in FIG. 6B.

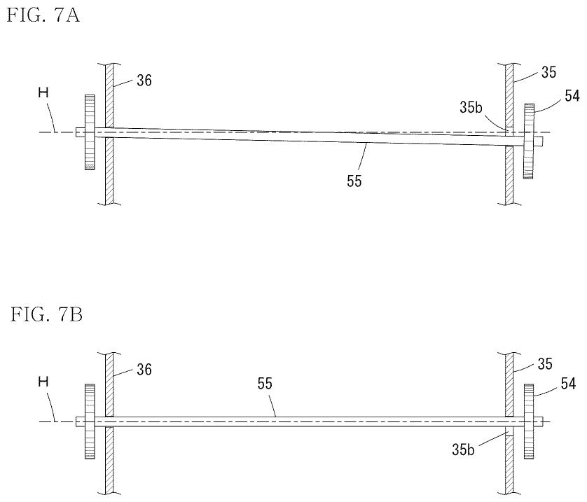

FIG. 7A and FIG. 7B illustrate displacement of the rotary shaft 55. FIG. 7A shows a posture of the rotary shaft 55 when the first gear 54 is at the first position. When the first gear 54 is in the first position, the rotary shaft 55 is not parallel to the horizontal line H and is inclined. In other words, when the first gear 54 is in the first position, the rotary shaft 55 is held in a posture not perpendicular to the pair of support plates 35 and 36.

FIG. 7B shows the posture of the rotary shaft 55 when the first gear 54 is in the second position. When the first gear 54 is in the second position, the rotary shaft 55 is in a horizontal posture parallel to the horizontal line H. That is, when the first gear 54 is in the first position, the rotary shaft 55 is held in a posture perpendicular to the pair of support plates 35 and 36.

The power transmission mechanism 50 has a configuration capable of moving the first gear 54 between the first position and the second position as described above. With such a configuration, the power transmission mechanism 50 can prevent damage to the teeth 53a of the partially toothless gear 53 and the teeth 54a of the first gear 54.

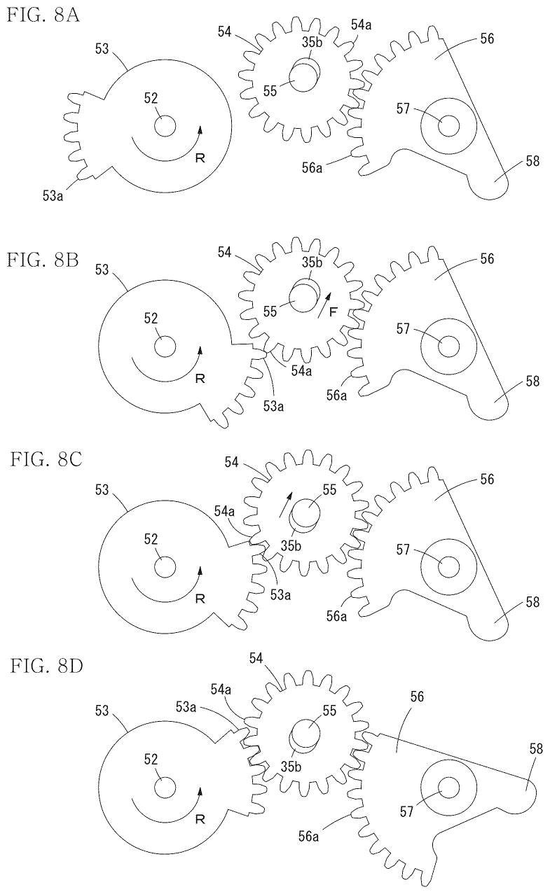

FIG. 8A, FIG. 8B, FIG. 8C, and FIG. 8D are diagrams illustrating operation of the power transmission mechanism 50. First, as illustrated in FIG. 8A, in a state where the partially toothless gear 53 is in the initial position, the power transmission mechanism 50 rotationally drives the drive gear 51 to rotate the partially toothless gear 53 in the R direction. When the teeth 53a of the partially toothless gear 53 is not in contact with the teeth 54a of the first gear 54, the first gear 54 and the second gear 56 are not changed. At this time, the first gear 54 is in the first position.

As shown in FIG. 8B, when the partially toothless gear 53 rotates, a tooth 53a of the partially toothless gear 53 comes into contact with a tooth 54a of the first gear 54 located at the first position. That is, the tip of tooth 53a of the partially toothless gear 53 and the tip of tooth 54a of the first gear 54 collide with each other. When the tooth tips of the partially toothless gear 53 and the first gear 54 collide with each other, the rotational force of the partially toothless gear 53 is not transmitted as a force for rotating the first gear 54. When the partially toothless gear 53 rotates in the R direction in a state in which the tooth tips of the partially toothless gear 53 and the first gear 54 collide with each other, the rotational force of the partially toothless gear 53 becomes force F that pushes up the first gear 54 in the longitudinal direction of the shaft receiving hole 35b and is transmitted to the first gear 54. As a result, the first gear 54 moves from the first position to the second position.

FIG. 8C shows a state in which the first gear 54 has moved to the second position. When the first gear 54 moves to the second position, the first gear 54 moves away from the partially toothless gear 53. Therefore, the impact caused by the collision between the partially toothless gear 53 and the first gear 54 is absorbed by the separation of the first gear 54 from the partially toothless gear 53. That is, the power transmission mechanism 50 moves the first gear 54 from the first position to the second position, thereby preventing the breakage of the tooth 53a of the partially toothless gear 53 and the tooth 54a of the first gear 54.

When the first gear 54 moves from the first position to the second position, the first gear 54 moves while maintaining a state of meshing with the second gear 56. That is, when the first gear 54 moves from the first position to the second position, the first gear 54 moves in a direction away from the partially toothless gear 53 while keeping the distance from the second gear 56 substantially constant.

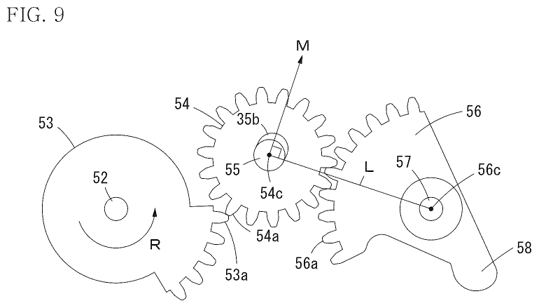

FIG. 9 is a view showing the moving direction of the first gear 54 in relation to the second gear 56. As shown in FIG. 9, when the first gear 54 is at the first position, the moving direction M of the first gear 54 is substantially perpendicular to the line L connecting the center 54c of the first gear 54 and the center 56c of the second gear 56. The elongated hole of the shaft receiving hole 35b is formed along such a moving direction M. By setting the moving direction M of the first gear 54 to be substantially perpendicular to the line L connecting the center 54c of the first gear 54 and the center 56c of the second gear 56, the first gear 54 moves from the first position to the second position while maintaining the state of meshing with the second gear 56.

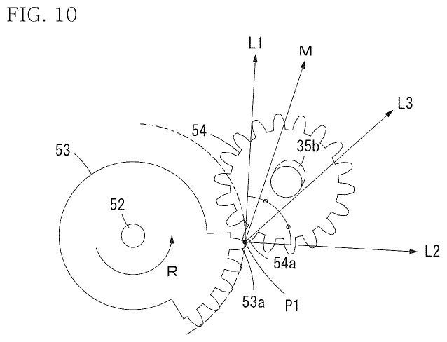

FIG. 10 is a view illustrating a moving direction of the first gear 54 in relation to the partially toothless gear 53. As shown in FIG. 10, the moving direction M of the first gear 54 is set between the tangent direction L1 and the normal direction L2 of the circle at the connection point P1 with the partially toothless gear 53. More preferably, as shown in FIG. 10, the moving direction M of the first gear 54 is set between the tangent direction L1 and an intermediate line L3 that bisects the angle between the tangent direction L1 and the normal direction L2. Thus, the first gear 54 appropriately moves from the first position to the second position by the rotation of the partially toothless gear 53.

Since the second gear 56 is joined to the second support portion 34, a load is applied to the second gear 56 in the rotational direction. Therefore, the rotational torque of the second gear 56 is larger than the rotational torque of the first gear 54. Therefore, when the first gear 54 moves from the first position to the second position, the second gear 56 does not rotate. When the first gear 54 moves from the first position to the second position, the second gear 56 restricts the rotation of the first gear 54.

The first gear 54 moves from the first position to the second position in a state where the rotation of the first gear 54 is restricted by the second gear 56. The partially toothless gear 53 rotates, whereas the first gear 54 does not rotate. Therefore, when the first gear 54 moves to the second position, as shown in FIG. 8C, the teeth 53a of the partially toothless gear 53 and the teeth 54a of the first gear 54 mesh with each other. That is, when the first gear 54 moves away from the partially toothless gear 53, the first gear 54 appropriately meshes with the partially toothless gear 53 without receiving a strong impact.

When the teeth 53a of the partially toothless gear 53 and the teeth 54a of the first gear 54 are engaged with each other, the power transmission mechanism 50 transmits the rotational force of the partially toothless gear 53 to the first gear 54 to rotate the first gear 54. At this time, the first gear 54 starts to rotate at the second position. When the first gear 54 is in the second position, the rotary shaft 55 is in a horizontal posture. Therefore, when the first gear 54 rotates at the second position, the rotary shaft 55 rotates smoothly. Then, as shown in FIG. 8D, the rotational force of the partially toothless gear 53 is transmitted to the second gear 56 through the first gear 54, so that the second gear 56 is rotated. As a result, the pressing portion 58 provided on the second gear 56 presses the second support portion 34 to move the second support portion 34 away from the first support portion 33. When the second support portion 34 moves away from the first support portion 33, the pressure contact state between the heating roller 31 and the pressure roller 32 is released.

Thereafter, when the heating roller 31 and the pressure roller 32 are brought into pressure contact with each other again, the partially toothless gear 53 is rotationally driven in a direction opposite to the R direction. Then, the partially toothless gear 53 returns to the initial position illustrated in FIG. 8A. When the partially toothless gear 53 returns to the initial position, the teeth 53a formed on the partially toothless gear 53 disengages from the first gear 54. Accordingly, the first gear 54 returns from the second position to the first position by its own weight.

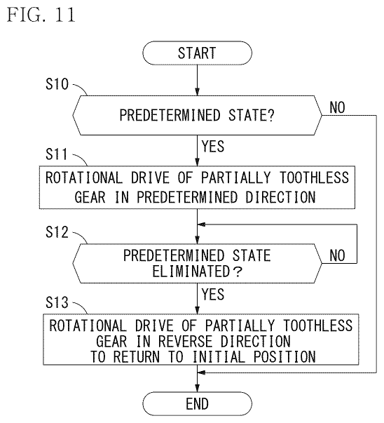

Next, FIG. 11 is a flowchart illustrating a procedure of driving control of the power transmission mechanism 50 by the controller 6. For example, while the image forming apparatus 1 is in the energized state, the controller 6 repeatedly executes processing based on FIG. 11.

When starting this process, the controller 6 determines whether or not the image forming apparatus 1 is in a predetermined state (step S10). For example, when execution of a print job is stopped or finished, the controller 6 determines that the image forming apparatus 1 is in the predetermined state. When determining that the image forming apparatus 1 is in the predetermined state (YES in step S10), the controller 6 rotationally drives the partially toothless gear 53 in a predetermined direction (direction R illustrated in FIG. 8A to FIG. 8D) from the initial position (step S11). As a result, the partially toothless gear 53 rotates, and when the partially toothless gear 53 and the first gear 54 mesh with each other, the first gear 54 moves from the first position to the second position. Therefore, the partially toothless gear 53 and the first gear 54 enter a state of meshing with each other without damaging the teeth 53a and 54a, and rotate the second gear 56. As a result, the heating roller 31 and the pressure roller 32 are separated from each other, and the nip portion is opened.

Next, the controller 6 determines whether or not the predetermined state has been resolved (step S12). When the predetermined state is eliminated (YES in Step S12), the controller 6 rotationally drives the partially toothless gear 53 in the reverse direction to return the partially toothless gear 53 to the initial position (Step S13). Thus, the heating roller 31 and the pressure roller 32 are brought into close contact with each other under a predetermined pressure. This state is a state in which a print job can be executed in the image forming apparatus 1. Therefore, for example, in a case where a print job is temporarily interrupted due to the occurrence of a jam, after the partially toothless gear 53 returns to the initial position, the execution of the print job is resumed.

As described above, the power transmission mechanism 50 of the present embodiment includes the partially toothless gear 53 in which the teeth 53a are formed only in a part of the peripheral edge portion, and the first gear 54 in which the plurality of teeth 54a are formed in the peripheral edge portion. In an initial state, the partially toothless gear 53 and the first gear 54 are in a disengaged state in which they are not in mesh with each other. The partially toothless gear 53 is rotationally driven from the initial state and is brought into an engaged state in which the partially toothless gear 53 is engaged with the first gear 54 to rotate the first gear 54. The first gear 54 is movable between the first position where the tip of tooth 54a and the tip of the tooth 53a of the partially toothless gear 53 collide with each other and the second position which is more distant from the partially toothless gear 53 than the first position. Therefore, when the first gear 54 is in the first position, if the teeth 53a of the partially toothless gear 53 and the teeth 54a of the first gear 54 collide with each other, the first gear 54 moves to the second position, so that the first gear 54 is appropriately engaged with the partially toothless gear 53. Therefore, the power transmission mechanism 50 can rotate the first gear 54 by engaging the partially toothless gear 53 with the first gear 54 without damaging the partially toothless gear 53 and the first gear 54.

Although one embodiment of the present invention has been described above, the present invention is not limited to the configuration described in the above embodiment. That is, various modification examples are applicable to the present invention. Hereinafter, several modification examples of the present invention will be described.

For example, in the above-described embodiment, the example of the configuration in which, when the partially toothless gear 53 returns to the initial position, the first gear 54 returns from the second position to the first position by its own weight after the teeth 53a formed on the partially toothless gear 53 disengages from the first gear 54 has been described. That is, in the above embodiment, since the shaft receiving hole 35b for moving the first gear 54 is formed obliquely in the vertical direction, the first gear 54 returns from the second position to the first position by its own weight. However, the shaft receiving hole 35b is not necessarily formed in the vertical direction. Therefore, the power transmission mechanism 50 may employ a configuration including a biasing member that returns the first gear 54 from the second position to the first position when the teeth 53a formed in the partially toothless gear 53 is disengaged from the first gear 54.

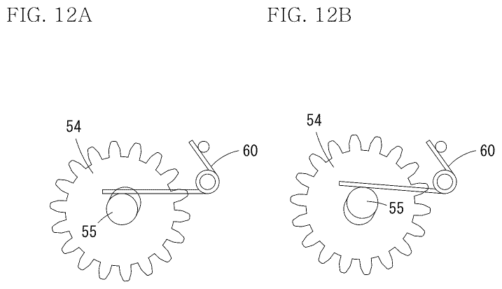

FIG. 12A and FIG. 12B are diagrams showing an example of the biasing member 60 that biases the first gear 54 toward the first position. As shown in FIG. 12A and FIG. 12B, the biasing member 60 is constituted by, for example, a torsion coil spring, one end of the spring is fixed, and the other end is engaged with the first gear 54 to press the first gear 54. For example, as shown in FIG. 12B, when the first gear 54 moves to the second position, the biasing member 60 is wound and tightened to bias the first gear 54 toward the first position. Due to the biasing force, the first gear 54 returns from the second position illustrated in FIG. 12B to the first position illustrated in FIG. 12A. Therefore, the biasing member 60 can forcibly return the first gear 54 from the second position to the first position with the disengagement of the teeth 53a formed on the partially toothless gear 53 from the first gear 54.

The power transmission mechanism 50 according to the above-described embodiment includes the second gear 56. However, the second gear 56 is not an essential component in the present invention.

Furthermore, the above embodiment illustrates the case where the power transmission mechanism 50 is mounted in the fixing device 30 of the image forming apparatus 1. However, a range in which the above-described power transmission mechanism 50 can be applied is not limited to the fixing device 30 and is not limited to the image forming apparatus 1.

Furthermore, the example in which the partially toothless gear 53 and the first gear 54 are formed of the PPS resin has been described in the embodiment described above. However, in the power transmission mechanism 50 having the above-described structure, the partially toothless gear 53 and the first gear 54 may be formed of a material other than the PPS resin.

Although embodiments of the present invention have been described and illustrated in detail, the disclosed embodiments are made for purposes of illustration and example only and not limitation. The scope of the present invention should be interpreted by terms of the appended claims.

What is claimed is:

1. A power transmission mechanism comprising:
a partially toothless gear in which teeth are formed only in a part of a peripheral edge portion and which is rotationally driven; and
a first gear having a plurality of teeth formed on a peripheral edge portion thereof, meshing with the teeth of the partially toothless gear by rotation of the partially toothless gear and being rotationally driven by the rotation of the partially toothless gear, wherein
the first gear is movable between a first position at which a tip of the plurality of teeth and a tip of the teeth of the partially toothless gear collide with each other and a second position farther from the partially toothless gear than the first position.

2. The power transmission mechanism according to claim 1, wherein
the first gear is located at the first position in a disengaged state in which the plurality of teeth does not mesh with the teeth of the partially toothless gear, and moves to the second position by receiving a rotational force of the partially toothless gear after tip of the plurality of teeth collide with tip of the teeth of the partially toothless gear at the first position with rotation of the partially toothless gear.

3. The power transmission mechanism according to claim 2, wherein
the first gear is, in accordance with the movement of the first gear to the second position, brought into an engaged state in which the plurality of teeth mesh with the teeth of the partially toothless gear.

4. The power transmission mechanism according to claim 3, wherein
the first gear, in the engaged state at the second position, rotates in accordance with rotation of the partially toothless gear.

5. The power transmission mechanism according to claim 1, further comprising:
a second gear provided to be engaged with the first gear, wherein
the first gear rotates the second gear.

6. The power transmission mechanism according to claim 5, wherein
a moving direction of the first gear connecting the first position and the second position is substantially perpendicular to a line connecting a center of the first gear and a center of the second gear when the first gear is at the first position.

7. The power transmission mechanism according to claim 5, wherein
the second gear maintains a state of meshing with the first gear when the first gear is in either the first position or the second position.

8. The power transmission mechanism according to claim 5, wherein
a rotational torque of the second gear is larger than a rotational torque of the first gear.

9. The power transmission mechanism according to claim 1, further comprising:
a rotation shaft rotatably holding the first gear, wherein
the rotation shaft is in an inclined posture inclined from a horizontal posture when the first gear is at the first position and is in the horizontal posture when the first gear is moved to the second position.

10. The power transmission mechanism according to claim 9, further comprising:
a pair of support plates supporting both ends of the rotary shaft, wherein
one of the pair of support plates to which the first gear is attached has a long hole for changing the rotary shaft between the inclined posture and the horizontal posture.

11. The power transmission mechanism according to claim 1, further comprising:
a biasing member that biases the first gear toward the first position.

12. The power transmission mechanism according to claim 1, wherein
the partially toothless gear and the first gear are formed of polyphenylene sulfide resin.

13. A fixing device comprising:
a heating roller;
a pressure roller;
a first support portion that supports the heating roller;
a second support portion that supports the pressure roller and is movable relative to the first support portion in a contact and separation direction;
a holding member that holds the second support portion and the first support portion in a state of being close to each other;
a pressing portion that presses the second support portion and the first support portion against holding force of the holding member in a direction in which the second support portion and the first support portion are separated from each other; and
a power transmission mechanism, wherein
the power transmission mechanism includes:
a partially toothless gear in which teeth are formed only in a part of a peripheral edge portion and which is rotationally driven; and
a first gear having a plurality of teeth formed on a peripheral edge portion thereof, meshing with the teeth of the partially toothless gear by rotation of the partially toothless gear and being rotationally driven by the rotation of the partially toothless gear, wherein
the first gear is movable between a first position at which a tip of the plurality of teeth and a tip of the teeth of the partially toothless gear collide with each other and a second position farther from the partially toothless gear than the first position, and the partially toothless gear is rotationally driven and rotates the first gear in a state in which the partially toothless gear and the first gear are engaged with each other so that the pressing portion is operated to separate the second support portion and the first support portion from each other.

14. An image forming apparatus comprising:
a fixing device; and
a controller, wherein
the fixing device comprises:
a heating roller;
a pressure roller;
a first support portion that supports the heating roller;
a second support portion that supports the pressure roller and is movable relative to the first support portion in a contact and separation direction;
a holding member that holds the second support portion and the first support portion in a state of being close to each other;
a pressing portion that presses the second support portion and the first support portion against holding force of the holding member in a direction in which the second support portion and the first support portion are separated from each other; and
a power transmission mechanism, wherein
the power transmission mechanism includes:
a partially toothless gear in which teeth are formed only in a part of a peripheral edge portion and which is rotationally driven; and
a first gear having a plurality of teeth formed on a peripheral edge portion thereof, meshing with the teeth of the partially toothless gear by rotation of the partially toothless gear and being rotationally driven by the rotation of the partially toothless gear, wherein
the first gear is movable between a first position at which a tip of the plurality of teeth and a tip of the teeth of the partially toothless gear collide with each other and a second position farther from the partially toothless gear than the first position, the partially toothless gear is rotationally driven and rotates the first gear in a state in which the partially toothless gear and the first gear are engaged with each other so that the pressing portion is operated to separate the second support portion and the first support portion from each other, and
the controller drives the partially toothless gear rotationally in a predetermined state to separate the second support portion and the first support portion from each other.

15. The image forming apparatus according to claim 14, wherein
the predetermined state is a state where execution of a print job is stopped.

16. The image forming apparatus according to claim 14, wherein
the predetermined state is a state in which a jam has occurred.
